(19) United States
(12) Patent Application Publication
(10) Pub. No.: US 2011/0231706 A1
(43) Pub. Date: Sep. 22, 2011

(54) System for Verifying Multimedia Players

(75) Inventor: Chi-Chen Cheng, Taipei City (TW)

(73) Assignee: iPeerMultimedia International Ltd, Taipei City (TW)

(21) Appl. No.: 12/240,528

(22) Filed: Sep. 29, 2008

(30) Foreign Application Priority Data
Dec. 6, 2007 (TW) 096220720

(51) Int. Cl. G06F 11/00

(52) U.S. Cl. 714/31; 714/E11.02

(57) ABSTRACT

Disclosed is a system for verifying a multimedia player. The system includes a multimedia player, a verification mechanism, a serial number generator, an audio and video data unit and a test mechanism. The multimedia player includes a communication interface and a storage unit. The verification mechanism includes a communication interface connected to the communication interface of the multimedia player. The serial number generator is connected to the communication interface of the verification mechanism. The audio and video data unit is connected to the communication interface of the verification mechanism. The test mechanism is connected to the communication interface of the multimedia player.

### FIELD OF THE INVENTION

The present invention relates to a system for verifying multimedia players and, more particularly, to a system for verifying multimedia players while ensuring the security of data recorded in the multimedia players during the production.

### DESCRIPTION OF THE RELATED ART

Referring to FIG. 3, there are shown a conventional multimedia player and a computer 7. During the production, original data are recorded in the multimedia player 6. The original data include numbers, texts, music, lyrics, images, films, and the serial number and code of the multimedia player 6 for example. For verification and tests after the production, the multimedia player 6 is directly connected to a computer 7. Additional data are transferred to the multimedia player 6 from the computer 7, and tests are run on the multimedia player 6 with the computer 7.

However, the original data are not coded before they are transferred to the computer 7 from the multimedia player 6 during the verification and the tests. The original data might illegally be spread. Moreover, as all of the transfer of the data, the verification and the tests are executed with the computer 7, it takes a lot of time for the computer 7 to finish these tasks because the data are massive and commands are complicated.

The present invention is therefore intended to obviate or at least alleviate the problems encountered in prior art.

### SUMMARY OF THE INVENTION

It is the primary objective of the present invention to provide a system for verifying multimedia players while ensuring the security of data recorded in the multimedia players during the production.

According to the present invention, the system includes a multimedia player, a verification mechanism, a serial number generator, an audio and video data unit and a test mechanism. The multimedia player includes a communication interface and a storage unit. The verification mechanism includes a communication interface connected to the communication interface of the multimedia player. The serial number generator is connected to the communication interface of the verification mechanism. The audio and video data unit is connected to the communication interface of the verification mechanism. The test mechanism is connected to the communication interface of the multimedia player.

Other objectives, advantages and features of the present invention will become apparent from the following description referring to the attached drawings.

### BRIEF DESCRIPTION OF THE DRAWINGS

The present invention will be described via the detailed illustration of two embodiments referring to the drawings.

FIG. 1 is a perspective view of a system for verifying multimedia players according to the preferred embodiment of the present invention.

FIG. 2 is a block diagram of the system shown in FIG. 1.

FIG. 3 is a perspective view of a conventional system for verifying multimedia players shown in FIG. 1.

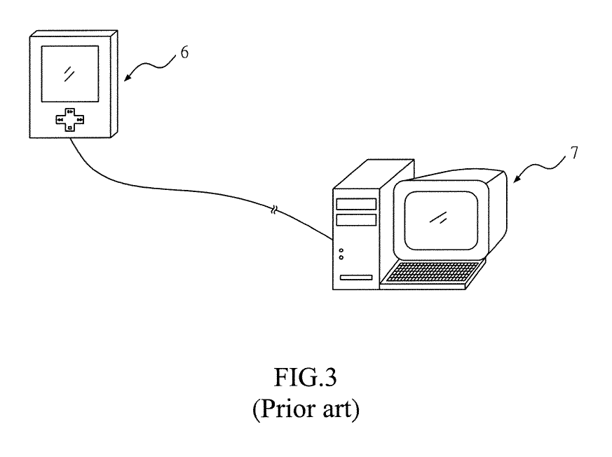

### DESCRIPTION OF THE PREFERRED EMBODIMENT

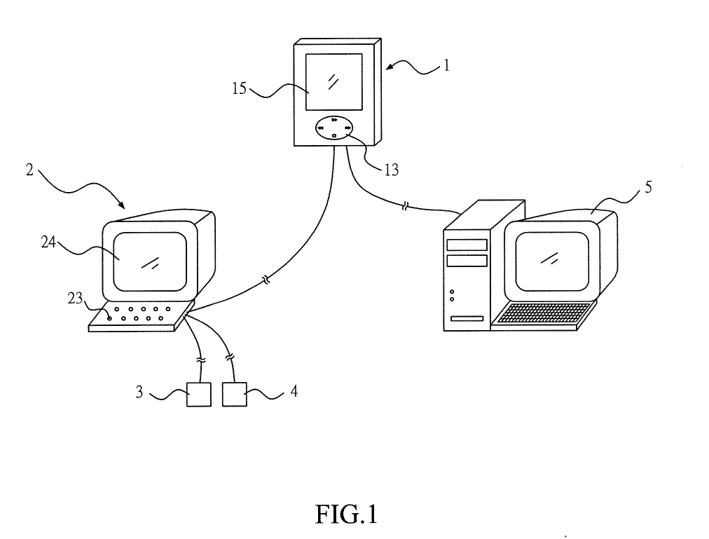

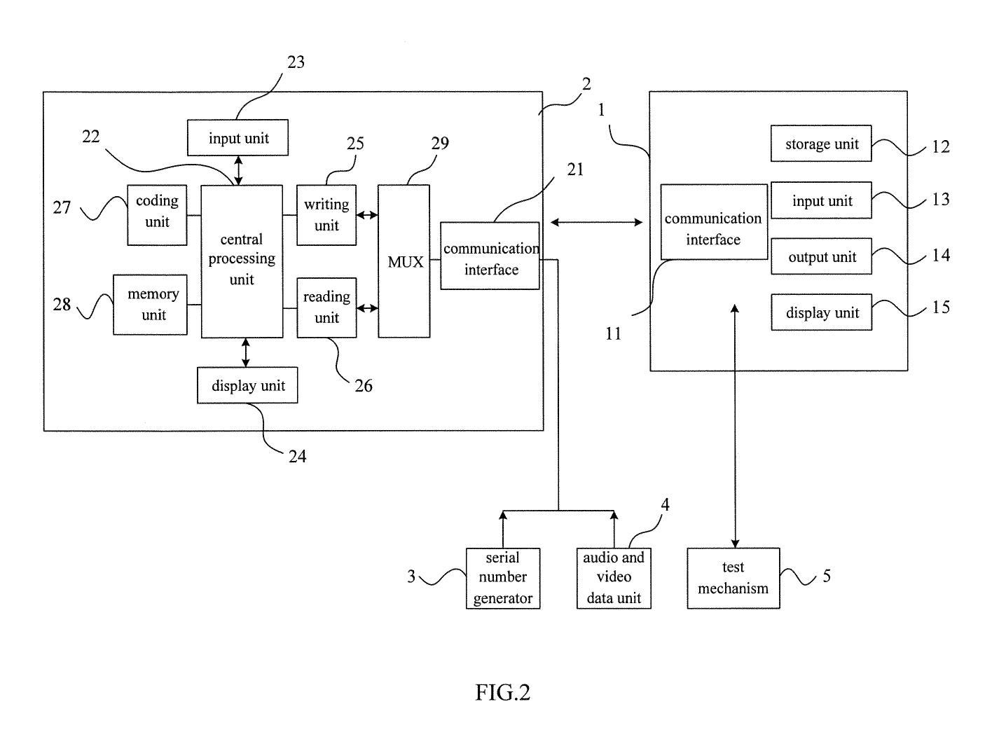

Referring to FIGS. 1 and 2, there is shown a multimedia player 1. The multimedia player 1 can be verified with a system for verifying multimedia players while ensuring the security of original data recorded in the multimedia players during the production according to the preferred embodiment of the present invention.

The multimedia player 1 is formed with a communication interface 11, a storage unit 12, an input unit 13, an output unit 14 and a display unit 15. The communication interface 11 may be a USB interface, a PCMCIA interface, a Car Bus interface or an SATA interface.

The system includes a verification mechanism 2, a serial number generator 3, an audio and video data unit 4 and a test mechanism 5. The verification mechanism 2 includes a communication interface 21, a central processing unit 22, an input unit 23, a display unit 24, a writing unit 25, a reading unit 26, a coding unit 27, a memory unit 28 and a multiplexer 29. The communication interface 21 may be a USB interface, a PCMCIA interface, a Car Bus interface or an SATA interface corresponding to the communication interface 11. The input unit 23, the display unit 24, the writing unit 25, the reading unit 26, the coding unit 27 and the memory unit 28 are connected to the central processing unit 22. Moreover, the writing unit 25, the reading unit 26 and the communication interface 21 are connected to the multiplexer 29.

The serial number generator 3 and the audio and video data unit 4 are connected to the communication interface 21. The test mechanism 5 is connected to the multimedia player 1.

In operation, the communication interface 11 of the multimedia player 1 is connected to the communication interface 21 of the verification mechanism 2. The original data are transferred to the verification mechanism 2 from the multimedia player through the input unit 23. The display unit 24 shows the original data. The serial number generator 3 and the audio and video data unit 4 transfer numbers, texts and audio and video data to the multiplexer 29 through the communication interface 21. The audio and video data include music, lyrics, images and films for example.

The central processing unit 22 receives the numbers, the texts and the audio and video data through the reading unit 26, and instructs the coding unit 27 to code the numbers, the texts and the audio and video data. Then, the central processing unit 22 may temporarily store the coded numbers, the coded texts and the coded audio and video data in the storage unit 28. The coded numbers, the coded texts and the coded audio and video data can be transferred from the storage unit 28 for further processing. Alternatively, the central processing unit 22 may instruct the writing unit 25, the multiplexer 29 and the communication interface 21 to transfer the coded numbers, the coded texts and the coded audio and video data to the communication interface 11 of the multimedia player 1. The multimedia player 1 stores the coded numbers, the coded texts and the coded audio and video data in the storage unit 12.

Numbers, texts and decoding identification numbers are provided to the multimedia player 1 from the test mechanism 5. The test mechanism 5 receives the numbers, the texts and the audio and video data from the storage unit 12 of the multimedia player 1 to determine whether the verification of the multimedia player 1 is successful.

As discussed above, the numbers, the texts and the audio and video data are coded during the verification. Leakage of the numbers, the texts and the audio and video data is avoided. That is, the security of the numbers, the texts and the audio and video data is ensured.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. system for verifying a multimedia player, the system comprising:
a multimedia player comprising a communication interface and a storage unit;
a verification mechanism comprising a communication interface connected to the communication interface of the multimedia player;
a serial number generator connected to the communication interface of the verification mechanism;
an audio and video data unit connected to the communication interface of the verification mechanism; and
a test mechanism connected to the communication interface of the multimedia player.

2. The system according to claim 1, wherein the multimedia player is an MP3 player.

3. The system according to claim 1, wherein the multimedia player comprises an input unit, an output unit and a display unit.

4. The system according to claim 1, wherein the communication interface of the multimedia player is selected from a group consisting of a USB interface, a PCMCIA interface, a Card Bus interface and an SATA interface.

5. The system according to claim 1, wherein the verification mechanism comprises:
a central processing unit;
an input unit connected to the central processing unit;
a display unit connected to the central processing unit;
a writing unit connected to the central processing unit;
a reading unit connected to the central processing unit;
a coding unit connected to the central processing unit;
a memory unit connected to the central processing unit; and
a multiplexer connected to the writing unit, the reading unit and the communication interface.

6. The system according to claim 4, wherein the communication interface of the verification mechanism is selected from a group consisting of a USB interface, a PCMCIA interface, a Card Bus interface and an SATA interface corresponding to the communication interface of the multimedia player.

7. The system according to claim 1, wherein the test mechanism is a computer.
